(19) United States
(12) Patent Application Publication
(10) Pub. No.: US 2004/0075233 A1
(43) Pub. Date: Apr. 22, 2004

(54) Suspension sub-frame assembly

(75) Inventor: Gary Gloceri, West Bloomfield, MI (US)

Correspondence Address: Michael A. Massing, BRINKS HOFER GILSON & LIONE, P.O. BOX 10395, CHICAGO, IL, 60610, US

(73) Assignee: Visteon Global Technologies

(21) Appl. No.: 10/681,780

(22) Filed: Oct. 8, 2003

Related U.S. Application Data
(62) Division of application No. 10/040,552, filed on Jan. 7, 2002.

(51) Int. Cl. B62D 21/11

(52) U.S. Cl. 280/124.109

(57) ABSTRACT

A suspension subframe for a vehicle is disclosed comprising a plurality of metal tubes standardized for use in vehicle exhaust systems, such as those defined by 1.5 mm gauge walls, that are affixed to each other. A structural foam material, such as an epoxy-based foam, is positioned within the metal tubes. Also provided is a method for making a suspension subframe for a vehicle comprising providing a plurality of metal tubes standardized for use in vehicle exhaust systems, such as those defined by 1.5 mm gauge walls. The metal tubes are welded together in a desired shape and a structural foam material, such as an epoxy based foam, is inserted into the tubes.

The present application is a divisional of U.S. patent application Ser. No. 10/040,552, filed on Jan. 7, 2002. No new matter has been added.

### FIELD OF THE INVENTION

The present invention relates to a suspension sub-frame assembly for a vehicle, and a method for making the suspension sub-frame. More specifically, the present invention relates to a lightweight suspension sub-frame assembly comprising thin-gauge metal tubes and structural polymer foam, and a method for making the suspension sub-frame.

### BACKGROUND OF THE INVENTION

It is known to mount a subframe on a vehicle body frame via mount bushings. Subframes are constructed in a variety of shapes. For example, a front subframe comprises a pair of spaced apart parallel longitudinal members and a pair of parallel lateral members connecting the front and rear ends of the longitudinal members to one another. These members form a rectangular annular shape. A rear subframe may be of a similar shape, or may be of a more complex, convoluted shape. A conventional, commercially available suspension subframe is made of a heavy steel material with a gauge of 2 mm to 5 mm, and generally over 4 mm. This material ensures that the subframe has the strength and dampening qualities necessary for use in a vehicle.

Such a construction is often heavy as well as expensive. Therefore, lighter versions of a suspension subframe have been investigated. Such subframes include a hollow subframe filled with pellets or other particles. Also, structural inserts have been affixed inside the subframe using adhesives.

### BRIEF SUMMARY OF THE INVENTION

According to one aspect of the present invention, there is provided a suspension subframe for a vehicle comprising a plurality of metal tubes standardized for use in vehicle exhaust systems affixed to each other. A structural foam material is positioned within the metal tubes.

According to another aspect of the present invention, there is provided a suspension subframe for a vehicle comprising a plurality of metal tubes standardized for use in vehicle exhaust systems and defined by metal walls having a gauge of about 1.5 mm. They are affixed to each other, and an epoxy-based structural foam material is positioned within the metal tubes at predetermined, localized areas within the tubes.

According to yet another aspect of the present invention, there is provided a method for making a suspension subframe for a vehicle comprising providing a plurality of metal tubes standardized for use in vehicle exhaust systems. The metal tubes are welded together in a desired shape and a structural foam material is inserted into the tubes.

According to still another aspect of the present invention, there is provided a method for making a suspension subframe for a vehicle comprising providing a plurality of metal tubes standardized for use in vehicle exhaust systems and having a gauge of about 1.5 mm. The metal tubes are welded together in a desired shape and an epoxy-based structural foam material is inserted into the metal tubes.

Other aspects of the present invention will become apparent in connection with the following description of the present invention.

### BRIEF DESCRIPTION OF THE DRAWINGS

FIG. 1 is a diagram of an embodiment of the undercarriage of a vehicle;

FIG. 2 is a view of an embodiment of a suspension subframe according to the present invention;

FIG. 3A shows an embodiment of a metal tube as for use with the present invention, with a structural foam cartridge inserted;

FIG. 3B shows an embodiment of FIG. 3A after the structural foam cartridge is allowed to cure and fill the metal tube;

FIG. 3C shows an embodiment of FIG. 3A where the structural foam cartridge is secured within the metal tube via another adhesive polymer;

FIG. 4 shows a portion of an embodiment of the present invention, wherein a structural foam polymer has been inserted into a bend in steel tubing; and

FIG. 5 shows an embodiment of the present invention wherein a structural foam is inserted within the metal tubes.

### DETAILED DESCRIPTION OF THE INVENTION

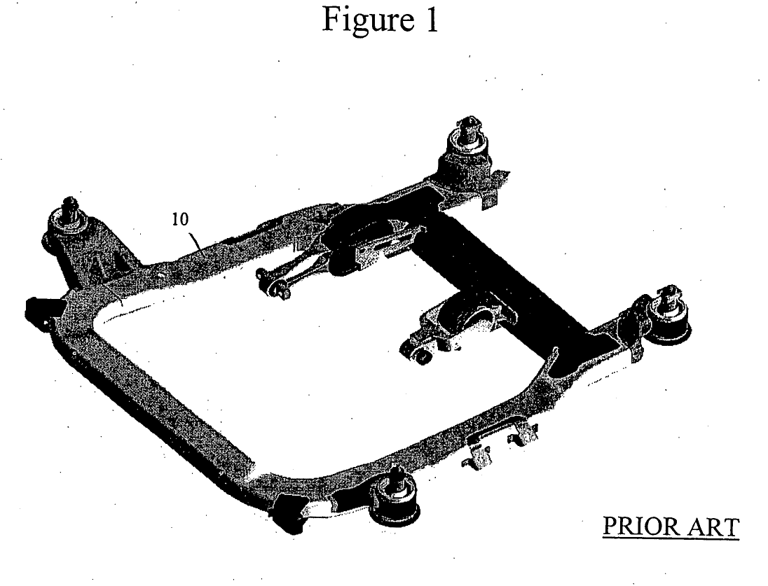

The suspension subframe of a vehicle, which normally hangs below the chassis of a vehicle, serves as a structural support for other parts of the vehicle. Some vehicle components, such as the vehicle engine, are suspended from or attached to the subframe in order to provide additional mechanical support. FIG. 1 shows an embodiment of a suspension subframe 10 in a vehicle. Other parts of the vehicle are connected, attached or otherwise extend from the suspension subframe 10.

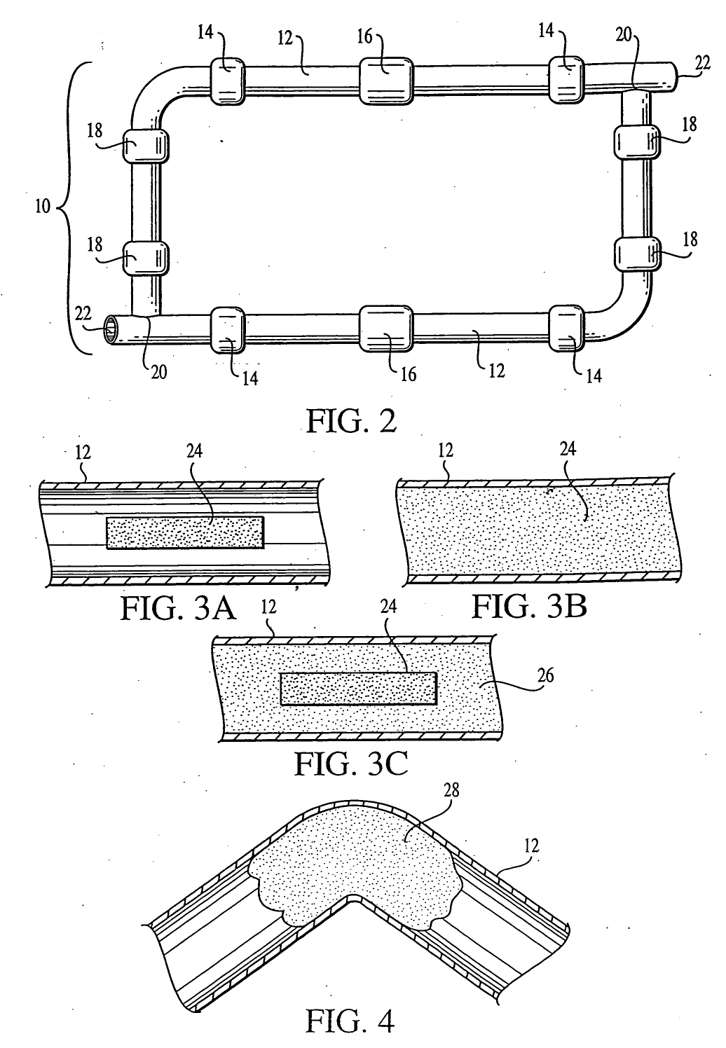

FIG. 2 shows an embodiment of a suspension subframe 10. To create this embodiment, a plurality of metal tubes 12 is used. As opposed to commercially available suspension subframes, wherein the tubing has a gauge of 2 mm to 5 mm, and generally around 4 mm, the present invention uses metal tubes 12 with a gauge of less than about 2 mm. Such metal tubes 12 are widely commercially available in a number of metal compositions and thicknesses. Particular success has been achieved with metal tubes 12 that have originally been designed for vehicle exhaust systems. Tubes that are standardized for use in vehicle exhaust systems generally have a thin gauge and preferably have a gauge between about 0.9 mm and about 1.8 mm, more preferably, a gauge of about 1.5 mm. Additionally, metal tubes for exhaust systems have the advantage of being readily available to vehicle manufacturers and are often stockpiled. Thus, it would be more efficient and less expensive for vehicle manufacturers to be able to use surplus exhaust tubes in a suspension subframe.

Body mounts 14, engine mounts 16 and suspension arm mounts 18 are welded over the metal tubes 12. These mounts give vehicle components such as the engine a firmer support on the suspension subframe, as well as help strengthen the suspension subframe connection to the body of the vehicle. The mounts can also be used as a junction for welding the metal tubes 12. In a preferred embodiment, two metal tube 12 ends are welded closed, as at 20, while the other two are left open, as at 22. This provides for an easy way to insert material within the metal tube 12 structure.

The metal tubes 12 contain a structural foam to provide strength. One embodiment of the structural foam is a structural foam cartridge 24, as depicted in FIG. 3A. Such a foam cartridge is readily available commercially, and could be made of any polymeric substance that creates a foam, such as polyurethane or epoxy-based structural foams. The foam pore size will vary by the specific vehicle and usage. A small-sized pore foam will provide extra rigidity, but with a heavier weight. Larger-sized pore foam is light weight, but less rigid. It can be determined by one skilled in the art as to the best size to use. An epoxy-based foam is preferred in the present application. In FIG. 3A, the structural foam cartridge 24 is inserted into the metal tubes 12. The structural foam cartridge 24 can be inserted into an end of the metal tubes 12 that has been left open, as at 22 in FIG. 2, or can be inserted before the welding process. The structural foam cartridge 24 is then be allowed to cure, as depicted in FIG. 3B. During the curing process, the structural foam cartridge 24 expands to fill the cross-section of the entire metal tube 12. Alternatively, an adhesive material 26 could be placed around the structural foam cartridge 24 to aid in attaching the structural foam cartridge 24 to the sides of the metal tube 12. In such an embodiment, the structural foam cartridge 24 has a significantly different density than the adhesive material 26 around it, as illustrated in FIG. 3C. The material combination acts like a fiber-reinforced composite material, bearing extra tensile load from stresses placed on the suspension subframe 10. The structural foam cartridge 24 and adhesive material 26 could alternatively be allowed to cure together, and form a material with a density gradient. Such an arrangement also allows for significant tensile strength within the metal tubes 12.

A second embodiment of a structural foam insert for the metal tubes 12 is a sprayable foam. The structural foam 28 is then inserted into the metal tubes 12 by spraying the structural foam 28 directly into the metal tubes 12. Such a structural foam 28 could be sprayed into the metal tubes 12 from the open ends 22. Alternatively, small holes could be made in the metal tubes 12 and the structural foam 28 sprayed into the metal tubes 12 via the holes. As with the structural foam cartridge 24, the structural foam 28 can be a polyurethane or epoxy-based foam; however, epoxy-based foams are preferred. The spraying method is a preferred method for inserting the foam, since the foam can be directed to specific areas within the metal tubes.

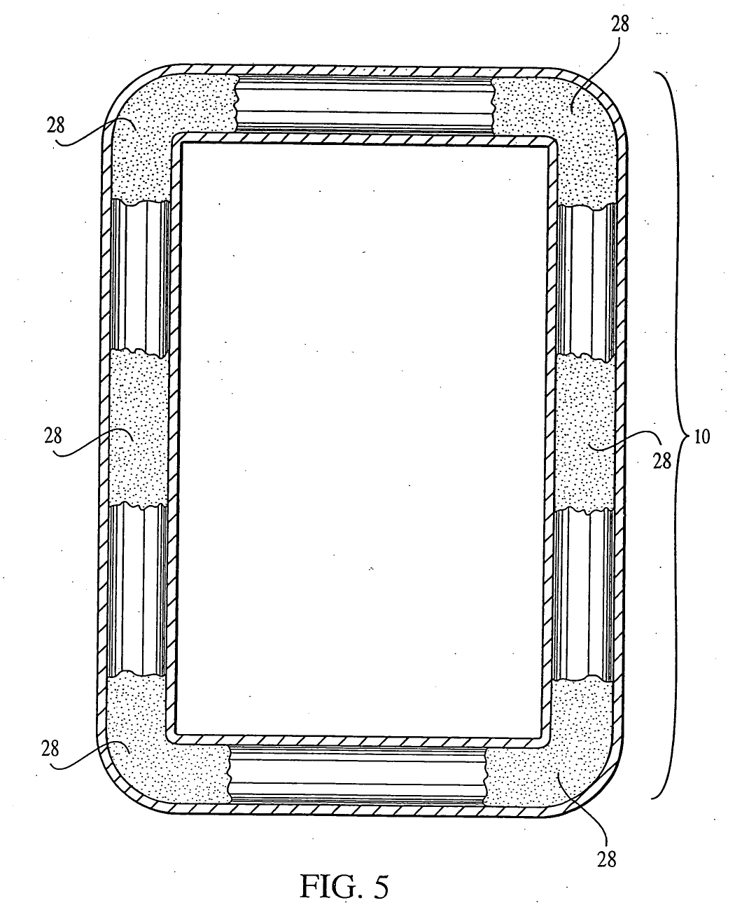

The structural foam 28 need not completely fill the metal tubes 12. For example, the structural foam 28 might only be used in specific areas where additional rigidity and strength are needed. FIG. 4 shows an embodiment of a bend in a metal tube 12. Structural foam 28 is only used at the bend in the metal tube 12 in order to reinforce its strength. This is further illustrated in FIG. 5, which shows an embodiment of a suspension subframe 10, designed in a rectangular shape, made of metal tubes 12. The suspension sub-frame only has structural foam 28 at certain areas where extra reinforcement is ideal. For example, the structural foam 28 might be used only at bends, in the middle of long, straight metal tubes 12, or at welding joins.

The use of the structural foam 28 at specific points is particularly important in withstanding crash forces. In an accident, a vehicle can sustain major structural damage. Adding structural stiffness in the suspension subframe 10 via localized placements of the structural foam 28 will not only cause the vehicle withstand some of the impact, but will also allow the vehicle to distribute the structural damage into areas of the vehicle that can be easily replaced or will ensure the safety of the vehicle operator.

Although the invention herein has been described in connection with a preferred embodiment thereof, it will be appreciated by those skilled in the art that additions, modifications, substitutions, and deletions not specifically described may be made without departing from the spirit and scope of the invention as defined in the appended claims.

1. A suspension subframe for a vehicle, said subframe comprising:
a plurality of metal tubes standardized for use in vehicle exhaust systems, said metal tubes affixed to each other; and
a structural foam material positioned within the metal tubes.

2. The apparatus of claim 1, wherein the metal tubes have a gauge of less than about 2 mm.

3. The apparatus of claim 2, wherein the metal tubes have a gauge between about 0.9 mm and about 1.8 mm

4. The apparatus of claim 3, wherein the metal tubes have about a 1.5 mm gauge.

5. The apparatus of claim 1, wherein the structural foam material is selected from the group of polyurethane-based foams and epoxy-based foams.

6. The apparatus of claim 5, wherein the structural foam material is an epoxy-based foam.

7. The apparatus of claim 1, wherein the structural foam material is localized at specific points in the tube.

8. A suspension subframe for a vehicle, said subframe comprising:
a plurality of metal tubes standardized for use in vehicle exhaust systems, each of said tubes defined by metal walls having a gauge of about 1.5 mm; and
an epoxy-based structural foam material positioned within the metal tubes, said structural foam material localized at predetermined areas in the tubes.

9. A method for making a suspension subframe for a vehicle comprising:
providing a plurality of metal tubes standardized for use in vehicle exhaust systems;
welding said metal tubes together in a desired shape; and
inserting a structural foam material into said tubes.

10. The method of claim 9, wherein the metal tubes provided have a gauge of less than about 2 mm.

11. The method of claim 10, wherein the metal tubes have a gauge between about 0.9 mm and about 1.8 mm.

12. The method of claim 11, wherein the metal tubes have a gauge of about 1.5 mm.

13. The method of claim 9, wherein the structural foam material further comprises an epoxy-based structural foam material.

14. The method of claim 13, wherein the insertion step further comprises the following steps:
inserting a structural foam cartridge into the metal tubes; and
allowing said structural foam cartridge to cure.

15. The method of claim 14, wherein the curing step requires an additional polymeric material to be inserted to promote curing.

16. The method of claim 13, wherein the insertion step is accomplished by spraying the structural foam material into the metal tubes.

17. The method of claim 16, wherein the spraying is done at specific, localized points within the metal tubes.

18. A method for making a suspension subframe for a vehicle, said method comprising the steps of:
providing a plurality of metal tubes, said metal tubes standardized for use in vehicle exhaust systems and having a gauge of about 1.5 mm;
welding said metal tubes together in a desired shape; and
inserting an epoxy-based structural foam material into said metal tubes.

19. The method of claim 18, said step of insertion comprising spraying the epoxy-based structural foam material into the metal tubes at specific, localized points.
